(19) United States
(12) Patent Application Publication
(10) Pub. No.: US 2010/0154575 A1
(43) Pub. Date: Jun. 24, 2010

(54) DRIVE PINION

(75) Inventor: Masato UENO, Nisshin-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 12/463,535

(22) Filed: May 11, 2009

(30) Foreign Application Priority Data
Dec. 19, 2008 (JP) 2008-323568

(51) Int. Cl. F16H 1/20

(52) U.S. Cl. 74/420

(57) ABSTRACT

There is provided a drive pinion having a balance established between the required flexural rigidity and torsional rigidity to reduce noise. The drive pinion located between a propeller shaft and a rear differential of a vehicle, transmitting the rotary driving power conveyed through the propeller shaft to the rear differential includes a shaft member rotatable about the center axis, and a cylindrical member rotatable about the center axis integrally with the shaft member. The cylindrical member is arranged extending from one end to the other end of the drive pinion, covering the outer circumferential face of the shaft member. The drive pinion is pivotally supported only at one end by a unit ball bearing.

This nonprovisional application is based on Japanese Patent Application No. 2008-323568 filed with the Japan Patent Office on Dec. 19, 2008, the entire contents of which are hereby incorporated by reference.

### BACKGROUND OF THE INVENTION

1. Field of the Invention

The present invention relates to drive pinions, particularly a drive pinion arranged between the propeller shaft and rear differential of a vehicle.

2. Description of the Background Art

The conventional art in association with a drive pinion incorporated in a vehicle such as an automobile is disclosed in, for example, Japanese Patent Laying-Open No. 2008-164020.

FIG. 5 is a sectional view of a rear differential unit 110 including a conventional drive pinion 174, incorporated in a vehicle. Rear differential unit 110 is mounted on an FF (Front engine Front drive) type 4WD vehicle, including a front drive shaft to which the driving power from the engine is directly transmitted, and a rear drive shaft 173 to which the driving power is transmitted from the front drive shaft via a propeller shaft 165.

Rear differential unit 110 includes a differential 171, and a wheel speed difference sensitive type viscous coupling 151. Attachment is established between differential 171 and viscous coupling 151 by a drive pinion 174. Drive pinion 174 has a pinion gear 178 provided at one end 176. Pinion gear 178 is engaged with a ring gear 172 of differential 171. Propeller shaft 165, viscous coupling 151 and drive pinion 174 are arranged on the axis of a center axis 101. Differential 171 is arranged on an axis along which rear drive shaft 173 extends, orthogonal to center axis 101.

Differential 171 and drive pinion 174 are housed in a differential carrier case 175. Viscous coupling 151 is housed in a differential front cover 152. Differential front cover 152 has a cylindrical configuration, provided to surround viscous coupling 151 at a circumference of center axis 101.

Viscous coupling 151 includes an inner shaft 155 to which an inner plate 154 is fastened, and a housing 153 to which an outer plate 156 is fastened. Housing 153 is connected to propeller shaft 165. Inner shaft 155 is connected to drive pinion 174. Inner shaft 155 and drive pinion 174 are provided rotatable in an integrated manner. Inner plate 154 and outer plate 156 face each other with silicon oil therebetween.

At the side of one end 176 that is one of the ends of drive pinion 174, a pair of conical roller bearings 122a and 122b facing each other supports drive pinion 174 rotatably to differential carrier case 175. Drive pinion 174 is also supported rotatably to differential front cover 152 by a rolling bearing 121 at the side of the other end 177. Conical roller bearings 122a and 122b and rolling bearing 121 are provided spaced apart in the axial direction (horizontal direction in the drawing) of center axis 101.

Housing 153 is supported by rolling bearings 121, 161 and 163 to rotate about center axis 101. Rolling bearing 121 located at the outer circumferential side of housing 153 includes an inner ring attached to housing 153, and an outer ring fitted in an inner circumferential portion 152c of differential front cover 152. Rolling bearing 121 pivotally supports housing 153 from the outer circumferential side, rotatable with respect to differential front cover 152. Rolling bearing 121 receives the load of precompression in the axial direction by a disc spring 162.

Rolling bearing 161 includes an inner ring fastened to drive pinion 174, and an outer ring fastened to housing 153. Rolling bearing 163 includes an inner ring fastened to inner shaft 155, and an outer ring fastened to housing 153. The outer ring of rolling bearing 163 is positioned relative to housing 153 by a snap ring 164. Rolling bearings 161 and 163 support housing 153 that rotates about center axis 101 to be relatively rotatable with respect to drive pinion 174 that rotates about the same axis as housing 153. Rolling bearing 163 also functions to establish the centering (center adjustment) of drive pinion 174 at other end 177.

In the case where there is no difference in the revolution speed between the front drive shaft and rear drive shaft 173, driving power is not transmitted to rear drive shaft 173. At this stage, drive pinion 174 and housing 153 rotate at the same speed. In the case where there is speed difference between the front drive shaft and rear drive shaft 173 such as when turning a corner, running on a snow-covered road, climbing a slope, starting the vehicle, increasing the speed or the like, the driving power is transmitted to rear drive shaft 173 by the function of viscous coupling 151. In this case, drive pinion 174 and housing 153 rotate at different speeds. Rolling bearings 161 and 163 exhibit their function as a bearing, supporting the relative rotational motion between drive pinion 174 and housing 153, only when there is speed difference between the front drive shaft and rear drive shaft 173.

In recent years, improving the fuel economy of the vehicle has become more critical in view of the regulation in the emission of carbon dioxide. Research along this line is in progress, such as reducing the number of bearings employed at the rear differential unit to reduce the frictional loss thereof by avoiding the use of a large-diameter bearing (rolling bearing 21 shown in FIG. 5) that exhibits a great frictional loss. In the case where rolling bearing 121 shown in FIG. 5 is eliminated, drive pinion 174 will be pivotally supported by only conical roller bearings 122a and 122b at one end 176, taking a cantilever supported manner.

A drive pinion that takes a cantilever-supported configuration is disadvantageous in the flexural rigidity of the drive pinion over the configuration where both ends are supported, as shown in FIG. 5. Degradation in the flexural rigidity of the drive pinion may cause amplification in the vibration due to the bending of the drive pinion and/or resonance with another proximate component. There was a problem that the muffled sound of the low-frequency region generated by the drive pinion will be increased.

In order to reduce the muffled sound caused by the drive pinion, the flexural rigidity of the drive pinion must be improved. From the standpoint of ensuring this flexural rigidity, the drive pinion must have a larger diameter than that of a conventional one to increase the moment of inertia of area of the drive pinion. Improving the flexural rigidity by increasing the diameter of the drive pinion will cause increase in the polar moment of inertia of area, which in turn will increase the torsional rigidity. However, increase in the torsional rigidity will induce another problem of increasing the whining sound of the high-frequency region by the drive pinion.

Namely, a balance between improving the flexural rigidity and reducing the torsional rigidity of the drive pinion must be established in order to reduce both the muffling sound and whining sound generated by the drive pinion.

### SUMMARY OF THE INVENTION

In view of the foregoing, a main object of the present invention is to provide a drive pinion having a balance established between the required flexural rigidity and torsional rigidity to reduce noise.

According to an aspect of the present invention, a drive pinion located between a propeller shaft and a rear differential of a vehicle transmits a rotary driving power conveyed via the propeller shaft to the rear differential. The drive pinion includes a shaft member rotatable about a center axis, and a cylindrical member rotatable about the center axis integrally with the shaft member. The cylindrical member is arranged extending from one end to the other end of the drive pinion, covering an outer circumferential face of the shaft member. The drive pinion is pivotally supported by a bearing only at one end.

The drive pinion has a spline tooth extending in the direction of the center axis, formed at one of the outer circumferential face of the shaft member and the inner circumferential face of the cylindrical member, and a spline groove extending in the direction of the center axis, formed at the other of the outer circumferential face of the shaft member and the inner circumferential face of the cylindrical member. The shaft member and the cylindrical member may be spline-fitted.

The drive pinion set forth above may have the inner circumferential face of the cylindrical member and the outer circumferential face of the shaft member fitted in abutting contact.

The drive pinion set forth above further includes a positioning member to determine the relative positioning of the shaft member and cylindrical member in the direction of the center axis. The positioning member may be arranged at the other end.

According to the drive pinion of the present invention, the flexural rigidity of the drive pinion is accommodated by both the shaft member and the cylindrical member whereas the torsional rigidity of the drive pinion is accommodated by only the shaft member. Therefore, the torsional rigidity can be reduced while the required flexural rigidity is ensured, with no degradation in the flexural rigidity of the drive pinion. Thus, aggravation of generation of the muffling sound and the whining sound can be avoided, allow reduction in the noise caused by the drive pinion.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram representing a configuration of a vehicle according to the present invention.

FIG. 2 is a sectional view of a rear differential unit mounted on a vehicle, including a drive pinion of the present embodiment.

FIG. 3 is a schematic sectional view of the drive pinion, representing the details of the spline-fitting portion.

FIG. 4 is a schematic diagram representing the engagement between a shaft member and cylindrical member at the abutting contact portion.

FIG. 5 is a sectional view of a rear differential unit mounted on a vehicle, including a conventional drive pinion.

### DESCRIPTION OF THE PREFERRED EMBODIMENTS

Embodiments of the present invention will be described hereinafter with reference to the drawings. In the drawings, the same or corresponding elements have the same reference characters allotted, and description thereof will not be repeated.

In the embodiments set forth below, each of the constituent elements is not necessarily mandatory in the present invention, unless stated otherwise. Moreover, the number and amount of the components in the embodiment set forth below are by way of example only, and not particularly limited thereto, unless stated otherwise.

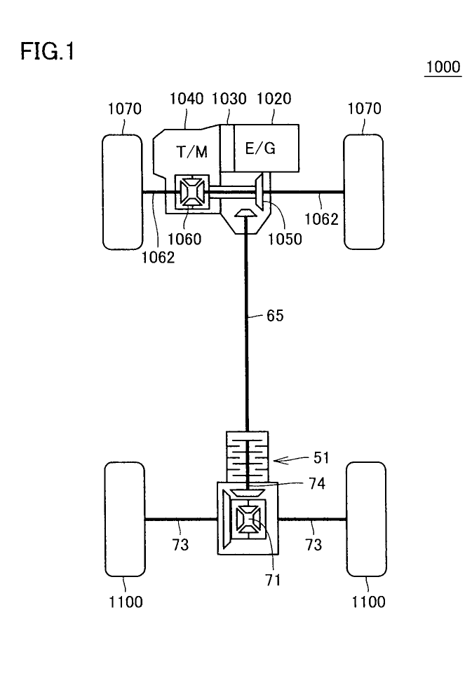

Referring to FIG. 1, a vehicle 1000 according to the present embodiment includes an engine 1020, a torque converter 1030, automatic transmission 1040, a transfer 1050, a front differential 1060, a front wheel 1070, a propeller shaft 65, a coupling device 51, a rear differential 71, and a rear wheel 1100.

Vehicle 1000 of FIG. 1 is an FF base four-wheel drive vehicle with front wheel 1070 as the main driving wheel and rear wheel 1100 as the subdriving wheel. The vehicle according to the present embodiment is not particularly limited thereto, and may be an FR (Front engine Rear drive) type vehicle, for example, with engine 1020 located at the front of the vehicle and driving with the rear wheel. Moreover, the vehicle of the present embodiment may have another power equipment such as a motor and/or battery incorporated as the power source, instead of engine 1020.

Torque converter 1030 is a fluid clutch provided between engine 1020 and automatic transmission 1040. Torque converter 1030 realizes the function to amplify the rotary driving power (torque) output from engine 1020. Although not shown in FIG. 1, torque converter 1030 includes a lock-up clutch to establish direct coupling between the input shaft and output shaft.

Automatic transmission 1040 may be a gear type transmission formed of a planetary gear unit, or a CVT (Continuously Variable Transmission) that modifies the gear ratio infinitely. The vehicle according to the present embodiment may include a manual transmission or an AMT (Automated Manual Transmission), instead of automatic transmission 1040.

Front differential 1060 is connected to front wheel 1070 via front drive shaft 1062. Transfer 1050 is connected to automatic transmission 1040 via the case of front differential 1060.

Transfer 1050 is a device to distribute the torque output from automatic transmission 1040 to the front wheel side and rear wheel side. A propeller shaft 65 transmitting the torque of engine 1020 to the rear wheel side is provided at transfer 1050. Propeller shaft 65 has the end of the rear wheel side connected to the input side of coupling device 51. Coupling device 51 has its output side connected to rear differential 71 via drive pinion 74. Drive pinion 74 is located between propeller shaft 65 and rear differential 71. Rear differential 71 is connected to rear wheel 1100 via rear drive shaft 73.

In vehicle 1000, a plurality of gears, splines, and the like are arranged at the region (torque transmission path) to transmit the torque from engine 1020 to front wheel 1070 or rear wheel 1100. For the sake of simplification, the plurality of gears and the like located at this path are represented in a simplified manner in FIG. 1. The torque generated at engine 1020 is transmitted to front wheel 1070 via torque converter 1030, automatic transmission 1040, front differential 1060 and front drive shaft 1062 constituting the drive system (drive line).

The torque generated at engine 1020 is transmitted to rear differential 71 via torque converter 1030, automatic transmission 1040, front differential 1060, transfer 1050, propeller shaft 65, coupling device 51, and drive pinion 74. Coupling device 51 controls the torque transmission between propeller shaft 65 and drive pinion 74. The torque transmitted to rear differential 71 is provided to rear wheel 1100 via rear drive shaft 73.

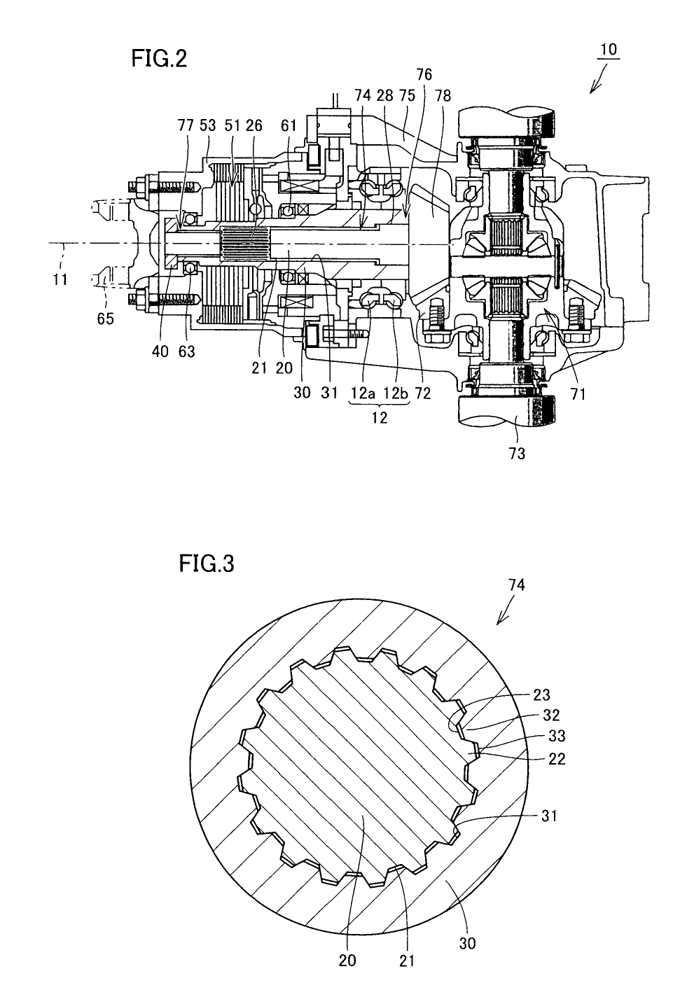

As shown in FIG. 2, rear differential unit 10 includes rear differential 71 and coupling device 51. Connection is established between rear differential 71 and coupling device 51 by drive pinion 74. Drive pinion 74 transmits the rotary driving power of engine 1020 conveyed through propeller shaft 65 to rear differential 71.

Drive pinion 74 includes pinion gear 78 provided at one end 76. Pinion gear 78 meshes with ring gear 72 of rear differential 71. Propeller shaft 65, coupling device 51 and drive pinion 74 are arranged on the line of center axis 11. Rear differential 71 is arranged on the axis along which rear drive shaft 73 extends, orthogonal to center axis 11.

Rear differential 71 and one end 76 side of drive pinion 74 are housed in differential carrier case 75. Drive pinion 74 is supported rotatable to differential carrier case 75 by a unit ball bearing 12 (a bearing unit formed of a pair of ball bearings 12a and 12b) at one end 76 side.

At the other end 77 side of drive pinion 74, coupling device 51 is located at the outer circumferential side of drive pinion 74. Coupling device 51 includes housing 53. Housing 53 is connected to propeller shaft 65. Housing 53 is supported by rolling bearings 61 and 63, rotatably relative to drive pinion 74 about center axis 11.

Drive pinion 74 and coupling device 51 are both rotary members that can rotate about center axis 11. Housing 53 is pivotally supported by rolling bearings 61 and 63 at the inner circumferential face. There is no member provided to support the outer circumferential face of housing 53. Drive pinion 74 has its other end 77 provided as a free end not supported by a fixture.

Namely, drive pinion 74 in rear differential unit 10 of the present embodiment takes a cantilever supported configuration, having only one end 76 pivotally supported by unit ball bearing 12 to allow revolution. As compared to a conventional rear differential unit 110 shown in FIG. 5, a rolling bearing 121 pivotally supporting the housing from the outer circumferential side is absent. Since rear differential unit 10 of the present embodiment does not have a large-diameter rolling bearing 121, any frictional loss that was caused by conventional rolling bearing 121 will be eliminated. As a result, fuel economy can be improved as compared to a conventional one.

In addition, unit ball bearing 12 is employed for the bearing that supports one end 76 of drive pinion 74 in a cantilever manner, instead of a conventional conical roller bearing. Moreover, instead of the pair of conical roller bearings, a ball bearing is employed for the bearing that pivotally supports rear drive shaft 73. Accordingly, rear differential unit 10 of the present embodiment is configured to further improve fuel economy by virtue of further reducing frictional loss caused by the bearing.

Drive pinion 74 takes an inner and outer double shaft structure, including a shaft member 20 identified as a shaft of a small diameter, and a cylindrical member 30 covering the outer circumferential face 21 of shaft member 20. Shaft member 20 is an example of an inner circumferential member arranged at the inner circumferential side of drive pinion 74. Cylindrical member 30 is an example of an outer circumferential member arranged at the outer circumferential side of drive pinion 74. Shaft member 20 is provided rotatable about center axis 11. Pinion gear 78 is attached to shaft member 20 corresponding to one end 76 side. Cylindrical member 30 engages with shaft member 20 at a spline fitting portion 26 and an abutting-contact portion 28, rotatable about center axis 11 integrally with shaft member 20.

Cylindrical member 30 extends along center axis 11 from one end 76 to the other end 77 of drive pinion 74. An inner circumferential face 31 of cylindrical member 30 formed in a tubular shape faces an outer circumferential face 21 of shaft member 20. Cylindrical member 30 is arranged to cover outer circumferential face 21 of shaft member 20. Unit ball bearing 12 has its inner ring fastened to the outer circumferential face of cylindrical member 30. Cylindrical member 30 is a supported cylindrical body, pivotally supported by unit ball bearing 12 in a rotatable manner.

Drive pinion 74 configured as set forth above has its flexural rigidity accommodated by two members, i.e. both of shaft member 20 and cylindrical member 30, and its torsional rigidity accommodated by only one member, i.e. shaft member 20. Cylindrical member 30 has an outer diameter of a dimension sufficient to ensure the required flexural rigidity. Shaft member 20 is formed to have a relatively small outer diameter so as to reduce the entire torsional rigidity of drive pinion 74.

Accordingly, the torsional rigidity of drive pinion 74 can be reduced while the required flexural rigidity is ensured, with no degradation in the flexural rigidity of drive pinion 74. By virtue of the sufficient flexural rigidity of drive pinion 74, generation of a muffled sound corresponding to low frequency during rotation of drive pinion 74 can be suppressed. Moreover, by virtue of the torsional rigidity of drive pinion 74 being reduced, generation of a whining sound corresponding to high frequency during rotation of drive pinion 74 can be suppressed. Thus, aggravation of generation of the muffling sound and the whining sound by drive pinion 74 can be avoided, allow reduction in the noise caused by drive pinion 74.

In the case where a conventional drive pinion formed of one member has a smaller outer diameter to reduce the torsional rigidity, the flexural rigidity will also be degraded, disallowing the reduction in both the muffled sound and whining sound. Drive pinion 74 of the present embodiment is configured to include two members, i.e. shaft member 20 located at the inner diameter side and cylindrical member 30 located at the outer diameter side. Accordingly, the torsional rigidity can be reduced while ensuring the flexural rigidity of drive pinion 74, allowing a balance of both the required flexural rigidity and torsional rigidity for drive pinion 74. Thus, noise can be suppressed.

An annular fastening nut 40 is attached to drive pinion 74 at the other end 77 side shown in FIG. 2. Fastening nut 40 is screwed on outer circumferential face 21 of shaft member 20. Fastening nut 40 located at the other end 77 side of shaft member 20 and pinion gear 78 secured to shaft member 20 at one end 76, having a large diameter relative to shaft member 20, serve to retain cylindrical member 30 in the direction of the center axis (direction along center axis 11, the horizontal direction in FIG. 2). Since cylindrical member 30 has respective ends supported by fastening nut 40 and pinion gear 78, cylindrical member 30 is fixed relative to shaft member 20 in the direction of the center axis.

Namely, fastening nut 40 plays the role of a positioning member, effecting the relative positioning of shaft member 20 and cylindrical member 30 in the direction of the center axis. By screwing fastening nut 40 on shaft member 20, the positioning and fixture of cylindrical member 30 with respect to shaft member 20 are realized. Thus, cylindrical member 30 can be readily assembled with shaft member 20 by disposing cylindrical member 30 to cover outer circumferential face 21 of shaft member 20, and then securing fastening nut 40 at the other end 77 of shaft member 20. By retaining cylindrical member 30 in the direction of the center axis by means of fastening nut 40, a more tight engagement between shaft member 20 and cylindrical member 30 can be achieved integrally. The flexural rigidity of drive pinion 74 can be further improved.

Fastening nut 40 may be formed to cause the thrust face corresponding to one end 76 contact the inner ring of rolling bearing 63. This allows the positioning of rolling bearing 63 by means of fastening nut 40. Accordingly, snap ring 164 that is the fastening ring for rolling bearing 163 shown in FIG. 5 can be eliminated. This contributes to reducing the cost.

The positioning member for positioning cylindrical member 30 is not limited to fastening nut 40 screwed to shaft member 20. For example, a ring-like or sheet-like member fastened by an arbitrary fixing method such as screw clamping, caulking, press fitting, and the like to other circumferential face 21 of shaft member 20 may be employed as the positioning member.

Referring to FIG. 3, a plurality of spline teeth 22 corresponding to outer circumferential face 21 projecting radially outwards are formed on outer circumferential face 21 of shaft member 20 constituting the inner diameter side member of drive pinion 74. Additionally, at inner circumferential face 31 of cylindrical member 30 constituting the outer diameter side member of drive pinion 74, a plurality of spline teeth 32 corresponding to inner circumferential face 31 projecting radially inwards are formed.

A plurality of spline grooves 23 into which spline teeth 32 of cylindrical member 30 fit are formed. Each groove 23 is located between two adjacent spline teeth 22 in the circumferential direction of outer circumferential face 21 of shaft member 20. A plurality of spline grooves 33 into which spline teeth 22 of shaft member 20 fit are also formed. Each spline groove 33 is located between two adjacent spline teeth 32 in the circumferential direction of inner circumferential face 31 of cylindrical member 30. As shown in FIG. 2, both spline teeth 22 and spline grooves 23 are formed at a region of outer circumferential face 21 of shaft member 20, extending in the direction of the center axis. Both spline teeth 32 and spline groove 33 are formed at a region of inner circumferential face 31 of cylindrical member 30, extending in the direction of the center axis.

Shaft member 20 and cylindrical member 30 are spline-fitted so that spline teeth 22 are fitted in spline grooves 33 and spline teeth 32 are fitted in spline grooves 23 at the same time. This ensures the rotation of shaft member 20 and cylindrical member 30 integrally. Cylindrical member 30 can be readily assembled with shaft member 20 by aligning the center of shaft member 20 and cylindrical member 30 together, and then moving cylindrical member 30 relative to shaft member 20 along the extending direction of shaft member 20.

The configuration of spline-fitting portion 26 is not limited to that shown in FIG. 3. Spline-fitting portion 26 may take any configuration as long as shaft member 20 and cylindrical member 30 can move back and forth in the extending direction thereof while rotating integrally to transmit the revolution force. Namely, the configuration of spline-fitting portion 26 is arbitrary as long as the spline teeth are formed at one of outer circumferential face 21 of shaft member 20 and inner circumferential face 31 of cylindrical member 30, and spline grooves having a face and configuration corresponding to the relevant spline teeth are formed at the other of outer circumferential face 21 of shaft member 20 and inner circumferential face 31 of cylindrical member 30.

Abutting-contact portion 28 is an engagement member particularly provided to improve the attaching accuracy of shaft member 20 and cylindrical member 30. The engagement between shaft member 20 and cylindrical member 30 by being fitted in abutting-contact facilitates the engaging operation while securing the concentricity of shaft member 20 and cylindrical member 30.

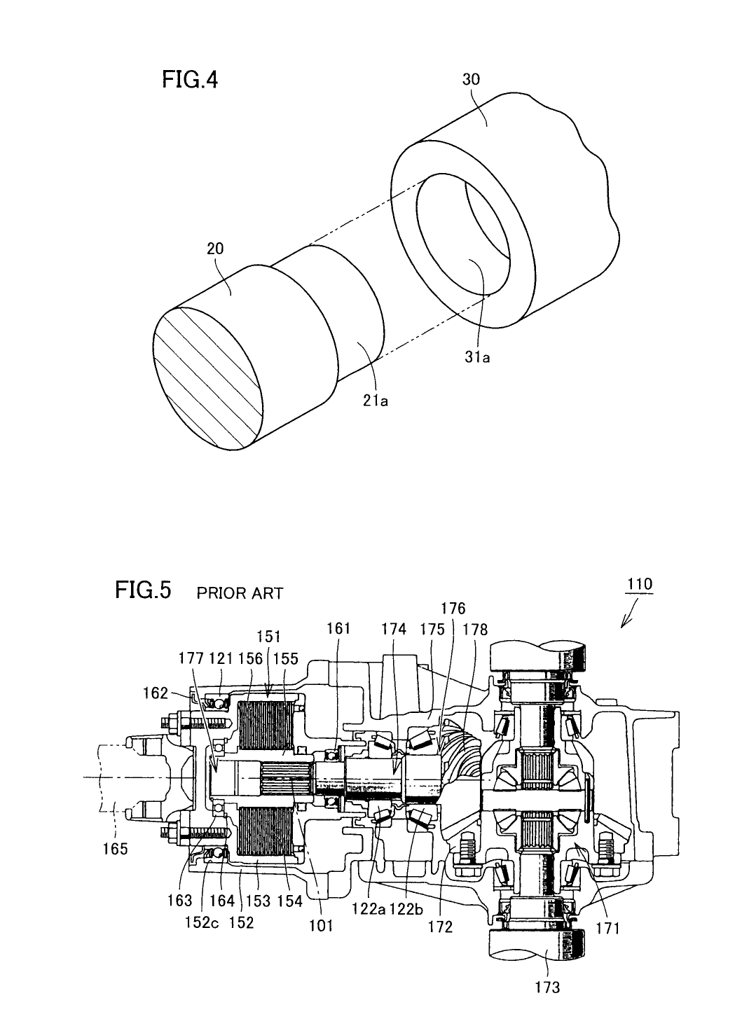

Referring to FIG. 4, a spigot 21 a is formed at a region of outer circumferential face 21 of shaft member 20. A socket 31a is formed at a region of inner circumferential face 31 of cylindrical member 30. Spigot 21a and socket 31a are dimensioned such that shaft member 20 and cylindrical member 30 are fitted in abutting contact. Specifically, the dimension of the outer diameter of spigot 21a and the inner diameter of socket 31a are selected to be substantially the same. Under the state where spigot 21a is introduced in socket 31a and shaft member 20 and cylindrical member 30 are fitted in abutting contact, the gap between the outer circumferential face of spigot 21a and the inner circumferential face of socket 31a is substantially zero. The outer circumferential face of spigot 21a and the inner circumferential face of socket 31a constitute a contact face where they abut against each other without any gap therebetween.

By forming a portion of inner circumferential face 31 of cylindrical member 30 as socket 31a and a portion of outer circumferential face 21 of shaft member 20 as spigot 21a, which are fitted together in abutting contact, a more tight coupling between shaft member 20 and cylindrical member 30 can be achieved integrally. Spline-fitting portion 26 and abutting-contact portion 28 constituting the engagement at two sites for engagement between shaft member 20 and cylindrical member 30 are provided spaced apart in the direction of the center axis. Specifically, abutting-contact portion 28 is provided at one end 76 of drive pinion 74. Spline-fitting portion 26 is provided at other end 77, spaced apart from abutting-contact portion 28 in the direction of the center axis. Accordingly, the flexural rigidity of drive pinion 74 can be further improved, allowing further reduction of the muffling sound generated during rotation of drive pinion 74.

The length of spigot 21a and socket 31a in the direction of the center axis must be selected to ensure the fitting in abutting contact. If the length is too long, it will become difficult to establish fitting in abutting contact between spigot 21a and socket 31a along the entire length of abutting-contact portion 28 in the direction of the center axis. For example, spigot 21a and socket 31a can be formed such that the length of abutting-contact portion 28 in the direction of the center axis is not more than 6 mm.

The configuration of abutting-contact portion 28 is not limited to that shown in FIG. 4. For example, a configuration is allowed in which a plurality of projections and dents of corresponding shapes are formed at the outer circumferential face of spigot 21a and the inner circumferential face of socket 31a, establishing engagement therebetween by fitting in abutting contact or press-fitting for coaxial engagement between shaft member 20 and cylindrical member 30.

The above-described embodiment is based on the case where a cantilever support configuration is established by having drive pinion 74 pivotally supported by unit ball bearing 12 at one end 76 where pinion gear 78 is secured. The drive pinion of the present invention provides the advantage of reducing noise generated by the drive pinion as long as it is formed in a double shaft structure, taking a cantilever support configuration in which only one end is pivotally supported by a bearing. In other words, drive pinion 74 may be pivotally supported by a bearing at other end 77 proximate to propeller shaft 65. The bearing for cantilever support of drive pinion 74 is not limited to unit ball bearing 12. An arbitrary bearing supporting drive pinion 74 radially may be employed.

Although shaft member 20 and cylindrical member 30 have been described based on an example in which they are spline-fitted at spline-fitting portion 26, the present invention is not limited to spline-fitting as long as engagement is established such that shaft member 20 and cylindrical member 30 are integrally rotatable. Engagement may be established by another arbitrary method. Further, shaft member 20 is not limited to a solid member as shown in FIG. 2, and may be formed to be hollow.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A drive pinion located between a propeller shaft and a rear differential of a vehicle, transmitting a rotary driving power conveyed via said propeller shaft to said rear differential, said drive pinion comprising:
a shaft member rotatable about a center axis, and
a cylindrical member rotatable about said center axis integrally with said shaft member,
said cylindrical member arranged extending from one end to an other end of said drive pinion, covering an outer circumferential face of said shaft member, and
said drive pinion pivotally supported by a bearing only at said one end.

2. The drive pinion according to claim 1, wherein
one of an outer circumferential face of said shaft member and an inner circumferential face of said cylindrical member has a spline tooth formed extending in a direction of said center axis, and the other of the outer circumferential face of said shaft member and the inner circumferential face of said cylindrical member has a spline groove formed extending in said direction of the center axis,
said shaft member and said cylindrical member are spline-fitted.

3. The drive pinion according to claim 1, wherein an inner circumferential face of said cylindrical member and an outer circumferential face of said shaft member are fitted in abutting contact.

4. The drive pinion according to claim 1, further comprising a positioning member determining a relative positioning of said shaft member and said cylindrical member in a direction of said center axis,
said positioning member arranged at said other end.
